(19) United States
(12) Patent Application Publication
(10) Pub. No.: US 2014/0009380 A1
(43) Pub. Date: Jan. 9, 2014

(54) ELECTRONIC APPARATUS AND METHOD OF STORING ACTIVITY THEREOF

(71) Applicant: Seungman Kim, McLean, VA (US)

(72) Inventor: Seungman Kim, McLean, VA (US)

(21) Appl. No.: 13/543,801

(22) Filed: Jul. 7, 2012

(51) Int. Cl. G09G 5/39; G06F 3/01

(52) U.S. Cl. 345/156; 345/531

(57) ABSTRACT

An electronic apparatus performs an operation to display an image according to the performed operation, and includes a storage unit, a display unit to display a plurality of screen images according to an activity of the electronic apparatus, and a control unit to control the storage unit to store the displayed screen images in order as a diary of the electronic apparatus, to read the stored screen images, and to controls the display unit to display the read screen images.

### BACKGROUND OF THE INVENTIVE CONCEPT

1. Field of the Inventive Concept

The present inventive concept relates to an electronic apparatus and method of storing activity of the electronic apparatus and generating a signal representing the stored activity.

2. Description of the Related Art

A conventional electronic apparatus, for example, a computer apparatus or a mobile apparatus, stores documents received from an external device or generated in the electronic apparatus. However, the conventional electronic apparatus does not store all activities of the electronic apparatus. Accordingly, a user of the conventional electronic apparatus may not know all activities of the conventional electronic apparatus.

Also, the conventional electronic apparatus stores a communication result after completion of the communication. However, the conventional electronic apparatus does not store all activities of the electronic apparatus. Accordingly, a user of the conventional electronic apparatus may not know all activities of the conventional electronic apparatus.

### SUMMARY OF THE INVENTIVE CONCEPT

The present inventive concept provides an electronic apparatus to store an activity thereof in a storage unit and to generate a signal representing the stored activity.

The present inventive concept provides a method of storing an activity of an electronic apparatus and generating a signal representing the stored activity.

The present inventive concept provides a computer readable medium to contain computer readable codes as a program to execute a method of storing an activity of an electronic apparatus and generating a signal representing the stored activity.

Additional features and utilities of the present inventive concept will be set forth in part in the description, which follows and, in part, will be obvious from the description, or may be learned by practice of the present inventive concept.

The foregoing and/or other features and utilities of the present inventive concept may be achieved by providing an electronic apparatus to perform an operation and to display an image according to the performed operation, the electronic apparatus including a storage unit, a display unit to display a plurality of screen images according to an activity of the electronic apparatus, and a control unit to control the storage unit to store the displayed screen images as a diary of the electronic apparatus.

The activity may be associated with an operation of a user selected menu of the electronic apparatus.

The activity of the electronic apparatus may not be associated with an operation of a user selected menu in the electronic apparatus.

The activity corresponding to the screen images may include one or more of an initial activity corresponding to an initiation of the menu, a final activity corresponding to a completion of an operation of the menu, and an intermediate activity between the initiation of the operation and the completion of the operation.

The activity corresponding to the screen images may include one or more of an interactive activity in which a user interacts with the electronic apparatus, and a non-interactive activity in which a user does not interact with the electronic apparatus.

The activity corresponding to the screen images may include one or more of an image only activity, a sound only activity, and a combination activity having an image and sound generating during the performance of the operation thereof.

The activity corresponding to the screen images may include one or more of an exposed activity, and an unexposed activity.

The electronic apparatus may further include a user interface to receive a user input to set up the activity, and the activity corresponding to the screen images may include one or more of a user setting activity which is set through the user interface and a non-user setting activity which is not set through the user interface.

The electronic apparatus may further include an interface to communicate with an external device, and the activity of the screen images may further include another activity occurring in the electronic apparatus according to data received from the external device.

The electronic apparatus may further include an interface to communicate with an external device, and the screen images may include an image representing another activity occurring in the electronic apparatus according to data received from an external device.

The control unit may generate a summary statement representing the screen images and controls the storage unit to store the generated summary statement.

The stored screen images may include a data compressed image and a non-data compressed image.

The display unit may display a main screen of the electronic apparatus and display one or more subsequent images according to a menu of the main screen, as the screen images of the activity, and the control unit may control the storage unit to store the screen images including the main screen and the subsequent images according to a change from the main screen to the one or more subsequent images or a selection of the menu of the main screen.

The control unit may control the storage unit to store the displayed screen images as a first unit file of the diary of the electronic apparatus, and the display unit may display a plurality of second screen images according to a second activity of the electronic apparatus. The control unit may further control the storage unit to store the displayed second screen images as a second unit file of the diary of the electronic apparatus.

The screen images and the second screen images may include a common screen image.

The control unit may control the storage unit to combine the first unit file and the second unit file into a main file of the diary of the electronic apparatus.

The control unit may read the stored screen images and control the display unit to display the read screen images as the diary of the electronic apparatus.

The control unit may read the stored screen images from the storage unit and may transmit the read screen images to an external device.

The foregoing and/or other features and utilities of the present inventive concept may also be achieved by providing an electronic apparatus to perform an operation and to display an image according to the performed operation, the electronic apparatus including a storage unit, a display unit to display a plurality of screen images according to an activity of the electronic apparatus, and a control unit to control the storage unit to store the displayed screen images in order as a diary of the electronic apparatus, to read the stored screen images, and to controls the display unit to display the read screen images.

The foregoing and/or other features and utilities of the present inventive concept may also be achieved by providing a method of an electronic apparatus to perform an operation and to display an image according to the performed operation, the method including displaying a plurality of screen images on a display unit according to an activity of the electronic apparatus, and controlling a storage unit to store the displayed screen images as a diary of the electronic apparatus.

### BRIEF DESCRIPTION OF THE DRAWINGS

These and/or other features and utilities of the present general inventive concept will become apparent and more readily appreciated from the following description of the exemplary embodiments, taken in conjunction with the accompanying drawings of which:

FIG. 1 is a block diagram illustrating an electronic apparatus according to an embodiment of the present inventive concept;

FIGS. 2A, 2B, and 2C are views illustrating a display device of the electronic apparatus of FIG. 1 according to an embodiment of the present inventive concept;

FIGS. 3A-3H are views illustrating a screen of the display unit of the electronic apparatus of FIG. 1 according to an embodiment of the present inventive concept;

FIGS. 4A-4E are views illustrating a screen of the display unit of the electronic apparatus of FIG. 1 according to an embodiment of the present inventive concept;

FIG. 5 is a flowchart illustrating a method of storing an activity of an electronic apparatus and displaying the stored activity according to an embodiment of the present inventive concept;

FIG. 6 is a flowchart illustrating a method of storing an activity of an electronic apparatus according to an embodiment of the present inventive concept;

FIG. 7 is a flowchart illustrating a method of generating a signal representing a stored activity of an electronic apparatus according to an embodiment of the present inventive concept;

FIGS. 8A and 8B are view illustrating a screen of a display unit of an electronic apparatus according to an embodiment of the present inventive concept; and

FIGS. 9A through 9F are views illustrating a screen of a display unit of an electronic apparatus according to an embodiment of the present inventive concept.

### DETAILED DESCRIPTION OF THE EXEMPLARY EMBODIMENTS

Reference will now be made in detail to exemplary embodiments of the present general inventive concept, examples of which are illustrated in the accompanying drawings, wherein like reference numerals refer to the like elements throughout. The exemplary embodiments are described below in order to explain the present general inventive concept while referring to the figures.

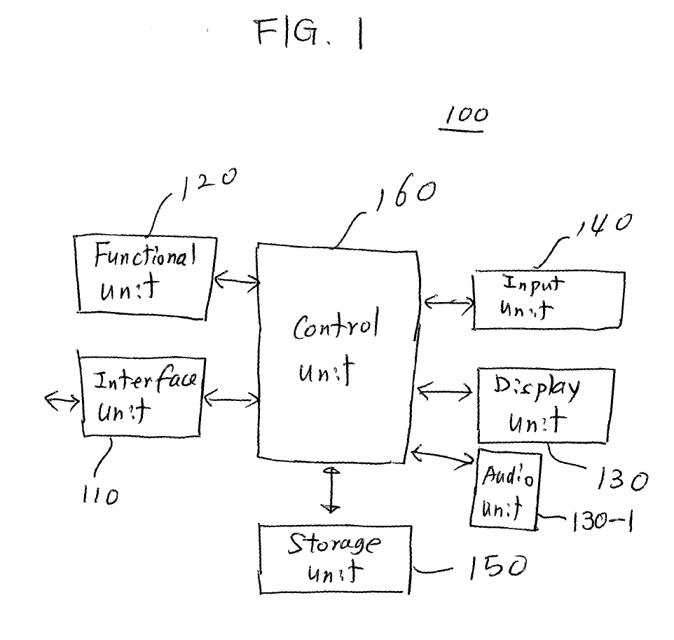

FIG. 1 illustrates an electronic apparatus 100 according to an embodiment of the present inventive concept. The electronic apparatus 100 may be a computer apparatus, a portable personal computer, a mobile device, a mobile phone, a mobile tablet apparatus, a mobile tablet computing apparatus, an audio or video recording and/or reproducing apparatus, a photographing apparatus, a communication device, etc.

The electronic apparatus 100 may include an interface unit 110, a functional unit 120, a display unit 130, an audio unit 130-1, an input unit 140, a storage unit 150, and a control unit 160.

The interface unit 110 may be connected to an external device through a weird or wireless communication line to transmit or receive data usable in a function of the electronic apparatus 100.

The functional unit 120 may be a unit to perform a function of the electronic apparatus 100. The functional unit may be an audio or video processing unit or a data processing unit to process data to generate a signal corresponding to an image to be displayed on the display unit 130 and/or sound to be generated through the audio unit 130-1. The functional unit 120 may be a unit to process a user input and to perform a function according to the user input. The functional unit may have an electrical portion and/or a mechanical portion to perform a function of the electronic apparatus 100.

The display unit 130 may have a screen to display an image corresponding to the signal generated from the functional unit 120. The screen may be a menu screen, a message screen, a video display screen, a user interface screen, a user input screen, and so on. The display unit 130 may be a touch panel to display an image and/or receive a user input.

The audio unit 130-1 may be a speaker unit to generate sound corresponding to a signal generated from the functional unit 120. The audio unit 130-1 may be installed on the display unit 130. The audio unit 130-1 may be one or more terminals to be connected to a corresponding external speaker to generate the sound.

The input unit 140 may be a button or a switch to control a function of the electronic apparatus 100 or select a function of the electronic apparatus 100. The input unit 140 may be an input unit of a touch panel of the display unit 140 to input a user input including a user command or user data to the functional unit 120, the interface unit 110. The input unit 140 may be a control input unit to control one or more units.

The storage unit 150 may be a storage to receive data and store the received data. The storage unit 150 may be a storage to store a program to initiate or operate the electronic apparatus 100.

The control unit 160 controls one or more units of the electronic apparatus and controls a function of the electronic apparatus 100. It is possible that the functional unit 120 may be formed with the control unit 160. That is, the control unit 160 may include the functional unit 120.

The control unit 160 stores activity of the electronic apparatus 100 as a diary of the electronic apparatus 100. The activity may include activities of the interface unit 110, the functional unit 120, the display unit 130, the audio unit 130-1, the input unit 140, the storage unit 150, and the control unit 160. For example, the activity may include displayed screens of the display unit 130, sound generations of the audio unit 130-1, manipulations of the input unit 140, and operations of the functional unit 120 and the interface unit 110 associated with one or more functions of the electronic apparatus. The operations of the functional unit 120 and the interface unit 110 may include processing or transmitting data, for example, receiving a telephone or text message, transmitting a telephone and text, communicating with an external device, processing data associated with a function of the electronic apparatus.

The activities may include an exposed (or sensed) activity and a non-exposed (or non-sensed) activity. The exposed activity may be exposed to or sensed by a user of the electronic apparatus 100 when the electronic apparatus 100 operates or generates a visual screen, sound, and/or a motion, for example, displaying images on a screen as image screens, generating sound, typing letters, displaying an interface to perform a setting or a function of the electronic apparatus 100, editing a text, such as deleting and adding letters. The non-exposed activity may not be exposed to or sensed by a user of the electronic apparatus 100 when the electronic apparatus 100 operates but does not generate a visual screen, sound, and/or a motion, for example, communicating with an external device, performing an internal operation, manipulating keys or switches, adjusting a volume, and performing an internal operation in the interface unit 110, the functional unit 120, the storage unit 150, and the control unit 160.

The activities may include an initial activity, a final activity, and an intermediate activity between the final activity and the initial activity.

The initial activity may be an activity to initiate an operation, application, or a function of the electronic apparatus 100. The initial activity may allow a user to select an operation, an application, or a function of the electronic apparatus 100. The initial activity may be an activity such that a user starts an operation. The initial activity may be followed one or more subsequent activities corresponding to the selected operation, application or function. The initial activity may be a turn on operation, a security (password) checking operation, an initial screen displaying operation, an initial sub-screen displaying operation following the initial screen displaying operation, a selecting operation to select a menu or icon, an interface displayed to perform a function thereof, etc. The initial activity may include a telephone connecting interface to initiate a telephone call, and an Internet connecting interface to allow a user to enter internet address or to select an icon for the Internet connection, and so on. The initial activity may be an initial screen displayed after a turn on operation or a security (password) checking operation, or a first screen with main menus or icons, for example.

The intermediate activity may be activity following the initial activity. The intermediate activity may include selecting a sub-menu or icon, inputting data or command, typing, deleting, adding, playing audio or video data, storing data, conversing with another user after telephone connection, displaying one or more web pages during the Internet connection, and so on, which are associated with the initial activity.

The final activity may include completing or finalizing the selected or intended operation, application, or function of the initial activity or the intermediate activity. After final activity, the electronic apparatus 100 may be returned to the initial activity. The final activity may include ending of the telephone conversation or disconnecting of the telephone connection, disconnecting of the internet connection, selecting a return menu, manipulating a key, button, icon to interrupt a current operation, application or function, and so on.

The activities may include an interactive activity in which a user interacts with the electronic apparatus 100 and a non-interactive activity in which a user does not interact with the electronic apparatus 100. The interactive activity may include inputting data or key or selecting a menu or icon. The non-interactive activity may include performing a function without interference by or interactive with a user, for example, receiving a message or telephone call, displaying a message indicating a receiving or received message or telephone call, receiving data, or processing data associated with a function of the electronic apparatus 100.

The activities may include an image only activity, a sound only activity, and a combination activity having an image and sound generating during the performance of the operation, application, or function thereof.

When a user uses the electronic apparatus 100, the electronic apparatus may perform the exposed and unexposed activities, the initial, intermediate, and final activities, and the interactive and non-interactive activities. Accordingly, the control unit 160 may store the above-described activities in the storage unit 150 according to the corresponding order or time as a diary of the electronic apparatus 100.

The electronic apparatus 100 may perform an operation, application, or function, by starting an initial screen of the initial activity followed by the intermediate activity and/or the final activity, and by returning to the initial screen after the intermediate activity and/or the final activity. The electronic apparatus 100 may store a series of activities corresponding to the same operation, application, or function, as a unit file in the storage unit 150. The electronic apparatus 100 may store one or more unit files to form a diary of the electronic apparatus 100.

The electronic apparatus 100 may store activities according to a user setting. The user setting may be selection of an activity type of the electronic apparatus 100. The activity type may be the exposed and/or non-exposed activities, the interactive and/or non-interactive activities, or the initial, intermediate, and/or final activities, for example. The activity type may be performance of the operation, the application, and/or function of the electronic apparatus 100. The electronic apparatus 100 may store the activities of the selected activity type as a unit file in the storage unit 150.

The electronic apparatus 100 provides a user with a user interface displayed on a screen thereof such that a user can select the unit files through the user interface, the selected unit files can be reproduced or displayed on the screen as a diary of the electronic apparatus 100, and thus a user can read, see or enjoy the user's activity with the electronic apparatus 100.

The control unit 160 may store a summary statement of the activities in the storage unit 150 as a diary of the electronic apparatus 100 to represent or indicate activities including the initiating, intermediate, and final activities, the exposed and exposed activities, or the interactive and non-interactive activities according to order or time as a diary of the electronic apparatus 100.

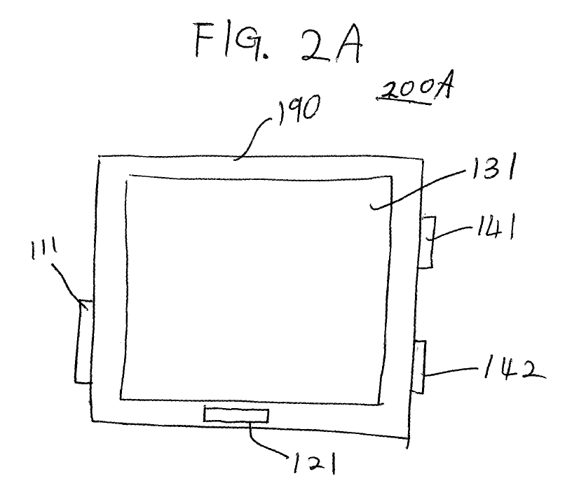

FIGS. 2A, 2B, and 2C illustrate examples, 200A, 200B, and 200C, respectively, of the electronic apparatus 100 of FIG. 1 according to an embodiment of the present inventive concept.

Referring to FIGS. 1 and 2A, the electronic apparatus 200A may have a housing 190 formed with a screen section 131 of the display unit 130 to display an image on a screen thereof, a terminal 111 of the interface unit 110 to communicate with an external device and to receive and transmit data or command associated with a function of the electronic apparatus 100, and one or more buttons 141 and 142 of the input unit 140 to input data or a command to the control unit 160, for example. The electronic apparatus may be formed as a monolithic or integrated body including the units illustrated in FIGS. 1, 2A, and 2B.

Referring to FIGS. 1 and 2B, the electronic apparatus 200B may have the housing 190 formed with a screen section 190a of the display unit 130 to display an image on a screen 132 thereof and a key section 190b of the input unit 140 to display key buttons or icons 143 of the input unit 140, a terminal 111 of the interface unit 110 to communicate with an external device and to receive and transmit data or command associated with a function of the electronic apparatus 100, and one or more buttons 141 and 142 of the input unit 140 to input data or a command to the control unit 160, for example. The key section 190b of the input unit 140 may be formed as one or more mechanical buttons or keyboard.

Referring to FIGS. 1 and 2C, the electronic apparatus 200C may have a first housing 191 formed with the display unit 130 to display an image on a screen 133 thereof and a second housing 192 formed with the input unit 140 having key buttons or icons 143 of the input unit 140, a terminal 111 of the interface unit 110 to communicate with an external device and to receive and transmit data or command associated with a function of the electronic apparatus 100, and one or more buttons 144 and 145 disposed on the first housing 191 and the second housing 192, respectively, as the input unit 140 to input data or a command to the control unit 160, for example. The second housing 192 may be formed with one or more mechanical buttons or keyboard to input or select data or command. The first housing 191 and the second housing 192 may be connected through a wired or wireless communication 193. The terminal 111 of the interface unit 110 may be installed on the first housing 191 and connected to the control unit 160 through the wired or wireless communication 193. It is possible that the functional unit 120, the audio unit 130-1, the storage unit 150, and the control unit 160 can be disposed in either one of the first housing 191 and the second housing 192 according to a user preference or design purpose. In this case, one of more units disposed on the first housing 191 of the electronic apparatus 100 are connected to the other units disposed on the second housing 192 of the electronic apparatus 100 through the wired or wireless communication 192.

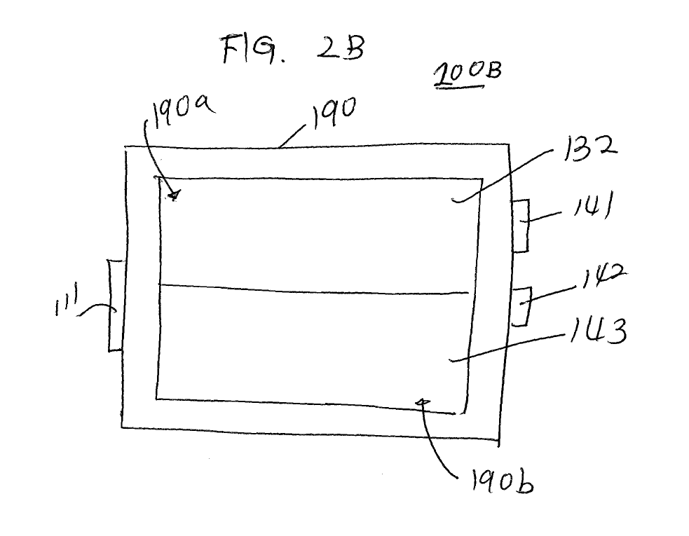

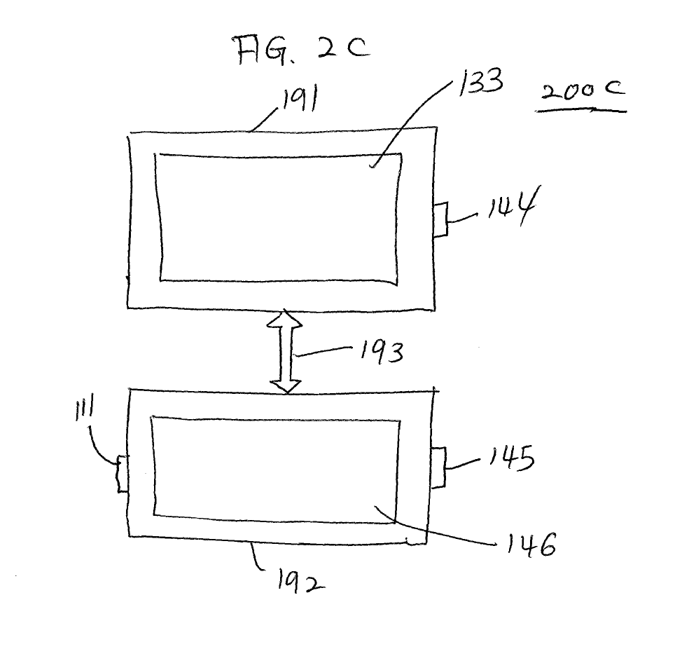

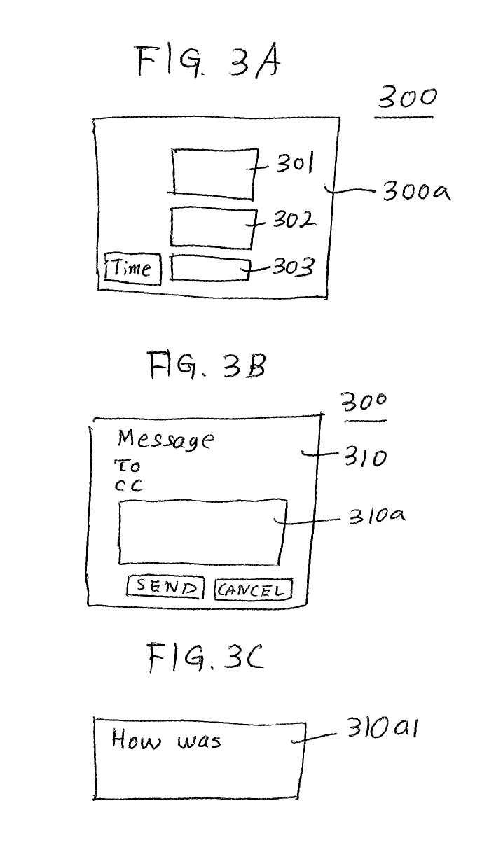

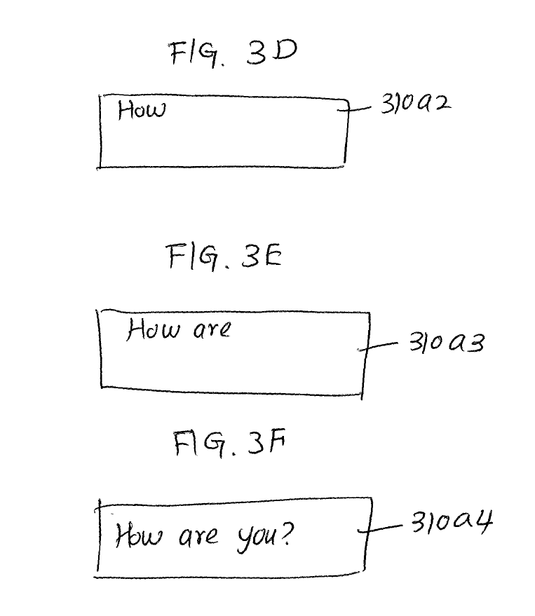

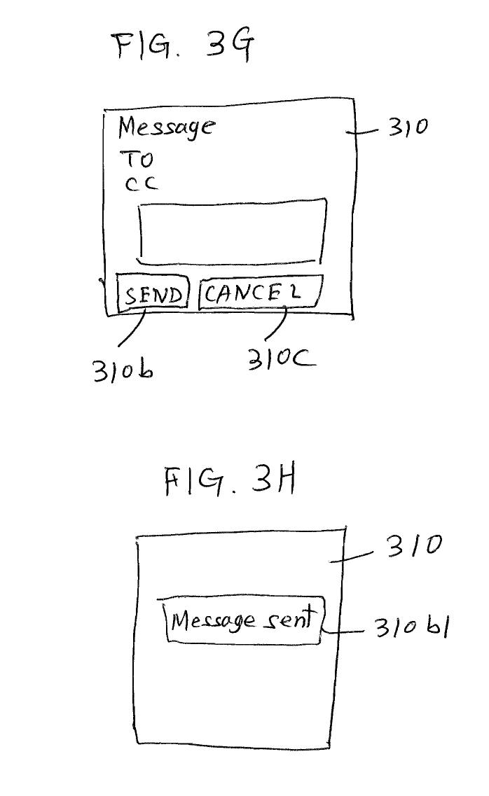

FIGS. 3A and 3B illustrate a screen 300 of the display unit 130 of the electronic apparatus of FIG. 1 according to an embodiment of the present inventive concept.

Referring to FIGS. 1 and 3A, the screen 300 may include a sub screen 300a to include an image having one or more menu or icons 301, 302, 303, . . . , and a time icon or sub-image to show or indicate a current time which may be referred to as an initial activity.

Referring to FIGS. 1 and 3B, when the menu or icon 301 is selected or inputted through the sub-screen image 300a using the input unit 140, the screen 300 may be changed to a screen image 310. The screen image 310 may include a section for name information (message) of the selected icon 301, a section for receiver information (TO and CC), and a section as a message box 310a, such that a user can input corresponding information and data (text message) using the input unit 140.

The control unit 160 may stores a series of the screens 300 of FIGS. 3A and 3B in order or in timely manner associated with a time in the storage unit 150.

FIGS. 3C through 3F illustrate sub-screens 310a1 through 310a4 of the display unit 130 of the electronic apparatus of FIG. 1 according to an embodiment of the present inventive concept.

Referring to FIGS. 1, 3B, and 3C, the sub-screen 310a1 illustrates letters typed by a user through the input unit 140. The sub-screen 310a1 show a first letter “H,” a second letter “o,” a third letter “w,” a space, a fourth letter “w,” a fifth letter “a,” and a sixth letter “s” in the order inputted from the user. The entering, inputting, or typing the respective letters may be referred to as the activity. The control unit 160 stores sub-screen images of the sub-screen 310a in the storage unit 150.

Referring to FIGS. 1 and 3B through 3D, the sub-screen 310a2 illustrates deleting the typed letters of “was,” that is deleting “s,” “a,” and “w,” in order. The deletion of the letters in order is referred to as the activity.

Referring to FIGS. 1 and 3B through 3F, the sub-screens 310a3 and 310a4 illustrate adding (or typing) letters of “are,” a space, and letters of “your?” in order. The adding of the letter in order is referred to as the activity, which is an intermediate activity of the messaging operation.

When a send button or icon 310b of FIG. 3B is selected after completing the message, the message is finalized and sent to a receiver through the interface unit 110 as illustrated in FIGS. 3G and 3H. When a cancel button or icon 310c is selected, the screen is returned to the screen 300 of FIG. 3A. The screen 300 may show a sub-screen 310b1 indicating a message transmission which may be referred to as the activity that is a final activity of the messaging operation.

When a user exits from one of the screens 300 and sub-screens 310a1 through 310a4 before completion of the messaging operation or when a return or cancel button is selected during the messaging operation, the control unit 160 stores the screens as initial and intermediate activities in the storage unit 150 such that a user can read or see the stored screens of activities as a diary of the electronic apparatus 100 later. Even if an operation is not completed or finalized, the operation including screens can be stored as activity and can be read and displayed as a diary of the electronic apparatus 100.

When the messaging operation is completed or finished, the control unit 160 stores all screens as activities of the messaging operation such that a user can read or see the stored screen of activities as a diary of the electronic apparatus 100.

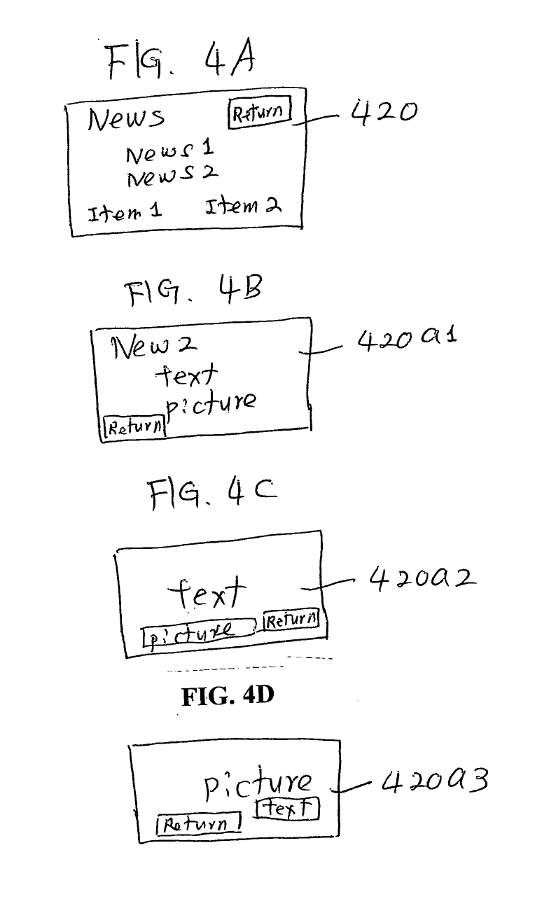

FIGS. 4A through 4D illustrate screens 420, 420a1, 420a2, and 420a3 of the display unit 130 of the electronic apparatus of FIG. 1 according to an embodiment of the present inventive concept.

When the menu or icon 302 is selected in the screen 300 of FIG. 3A, the screen 300 may be changed to a screen image 420. Here, the menu or icon 302 may be an Internet connection or an application to connect the electronic apparatus 100 to a server or an Internet supplier through an Internet network. The screen image 420 may a web page including an image of a title “News,” images of News 1 and News 2, and items 1 and 2 for additional news or displays. The

Referring to FIGS. 4A and 4B, when a menu or icon of News 2 is selected, the screen image 420 is changed to the screen image 420a1 to show a title of News 2 together with text and picture.

FIGS. 4A and 4B illustrate screen images 420a2 and 420a3, respectively, to display a text when the text of FIG. 4B is selected and to display a picture when the picture of FIG. 4B is selected. It is possible that one of the screens 420a1 through 420a3 can be returned to the screen 420 or the screen 300a of FIG. 3A. In this case, the control unit 160 stores the above describe activities in the storage unit 150 as a diary of the electronic apparatus 100.

When the Internet browsing operation is interrupted, not completed, the above-described activities of the incomplete portion of the internet browsing operation can be stored in the storage unit 150 as a diary of the electronic apparatus 100.

The internet browsing operation may include an access to a social networking, an access to an Internet service provider, an access to an internet home page, an access to another electronic apparatus, and/or a communication occurring according to the access thereto. The screen images may include images displayed during the above internet browsing operation including the above-described access and communication. The corresponding screen images displayed on the display unit 130 can be stored in the storage unit 150.

When the internet browsing operation is completed and then returned to the screen 300 of the initial activity, the above-describe activities can be stored in the storage unit as a diary of the electronic apparatus 100.

The above-describe activities can be stored as a file in the storage unit 150. When the electronic apparatus 100 is changed from the initial activity, such as the screen 300, the control unit stores the screen 300 of the initial screen, subsequent screens as the intermediate activities, and a final screen as the final activity as a file in the storage unit 150.

The screens changed between the screens 300 of the initial activity may be stored as a sub-file in the storage unit 150. Accordingly, the storage unit 150 may store a plurality of sub-files in order as a diary file for a predetermined period of time. It is possible that a designated event or a predetermined operation or function, for example, text messaging, internet browsing, executing an application, etc., can be set to be stored as a diary of the electronic apparatus 100. It is also possible that when a plurality of sub file are stored, the stored sub-filed can be sorted or classified as a designated event or predetermined operation or function as a designated file, or the sorted or classified filed can be stored in the storage unit 150 as a designated file.

In this case, a user can read the stored sub-files or select and read the designated file as a diary of the electronic apparatus 100. Accordingly, a user can see all activities or selected activities happened in the electronic apparatus as a diary of the electronic apparatus 100.

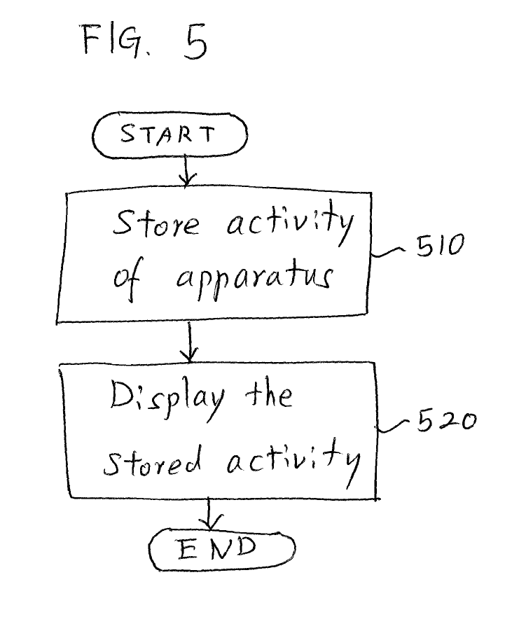

FIG. 5 is a flowchart illustrating a method of storing an activity of an electronic apparatus and displaying the stored activity according to an embodiment of the present inventive concept. The method may include storing activities of an apparatus at operation 510 and displaying the stored activities at operation 520. The displaying the stored activities may include generating sound corresponding to the displaying activities.

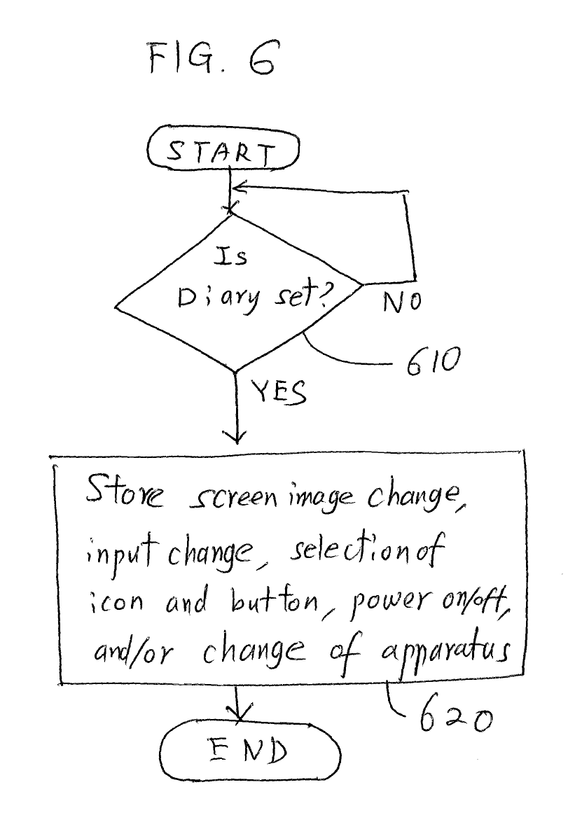

FIG. 6 is a flowchart illustrating a method of storing an activity of an electronic apparatus according to an embodiment of the present inventive concept. It is determined whether a diary is set at operation 610. When the diary is set in an electronic apparatus, an activity of the electronic apparatus is stored in a storage unit of the electronic apparatus at operation 620. The storing may include storing screen image changes, input changes, selection of icon or button, power on/off changes, and/or a change of the electronic apparatus, for example.

FIG. 7 is a flowchart illustrating a method of generating a signal representing a stored activity of an electronic apparatus according to an embodiment of the present inventive concept. It is determined whether a diary is selected at operation 710. When the diary is selected, the electronic apparatus generates a signal representing a stored activity. The electronic apparatus may reproduce a stored diary by displaying a screen and/or generating sound.

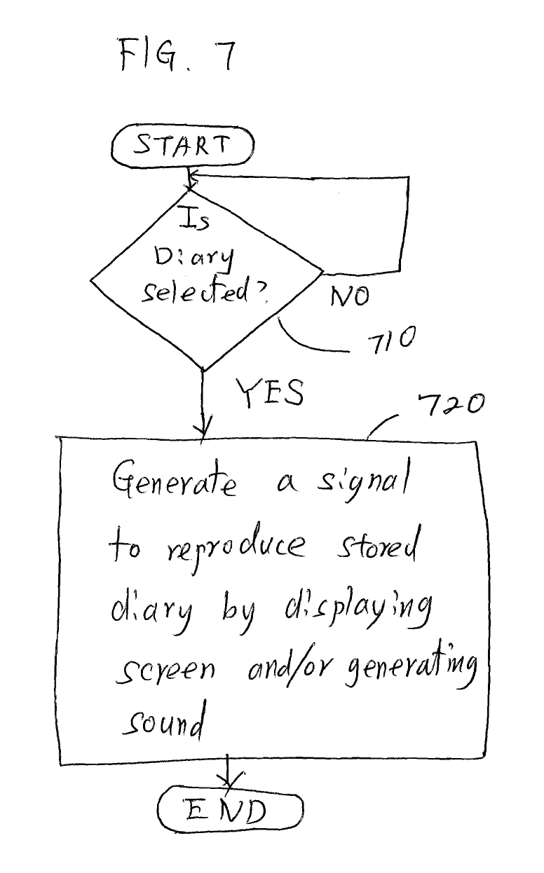

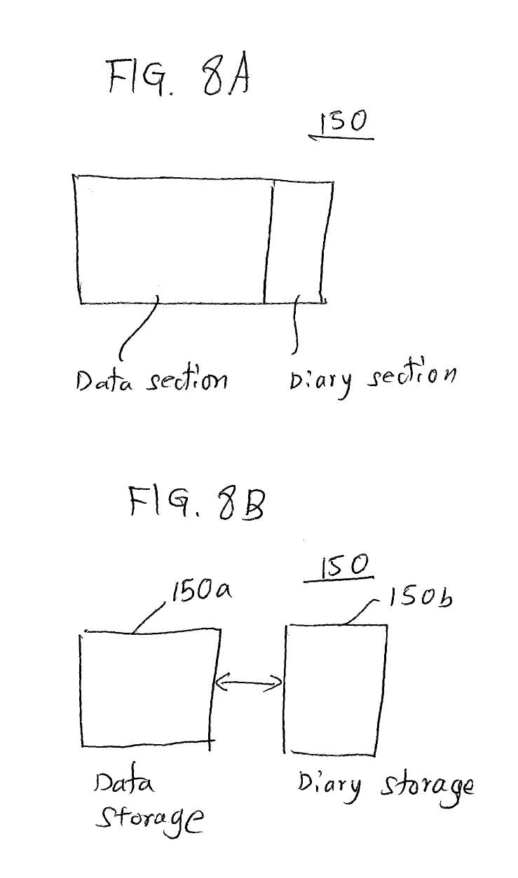

FIGS. 8A and 8B are view illustrating a storage unit 150 of an electronic apparatus according to an embodiment of the present inventive concept. The storage unit 150 may include a data section and a diary section as illustrated in FIG. 8A. The data section may be a first storage space of the storage unit 150 to store data associated with a program (operation, application, and/or function) of the electronic apparatus, and the diary section may be a second storage space of the storage unit 150 to store a diary of the electronic apparatus. The storage unit 150 may have two or more separate storages connectable through data or signal lines as illustrated in FIG. 8B. The separate storages include a data storage to store data associated with a program (operation, application, and/or function) of the electronic apparatus, and a diary storage to store a diary of the electronic apparatus.

When an activity of the electronic apparatus include a motion image, for example, displaying a movie, it is possible that all images of the movie can be stored in the storage unit 150. It is also possible that movie images associated with a user key manipulation or a user activity can be stored in the storage unit 150. It is possible that movie images without a user interaction with the electronic apparatus may not stored. That is, when a movie is selected in a user interface as an initial activity or an interactive activity and then played on a display unit as an intermediate activity, it is possible that a user enjoy the movie with or without controlling a volume control or other user activity to control the movie or to select a menu or a sub-menu thereof as an intermediate activity. During the intermediate activity, a control unit of the electronic apparatus may detect a user activity on the electronic apparatus and control the storage unit to skip or not store the movie images between user activities during the movie, but store the movie images played at a time of the user activity. It is also possible that the electronic apparatus receive a signal or data from an external device during playing the movie on the display unit, the control unit may control the storage unit to store the movie image at a time of the communication with the external device. Accordingly, the entire portion of the movie can be stored, and also a portion of the movie can be stored in the storage unit. In this case, a control unit of the electronic apparatus may generate a user interface to set a user setting of which portion of a movie involving activity is stored as a diary of the electronic apparatus, and the electronic apparatus may store the movie images according to the user setting. In this case, a storage space of the storage unit 150 to store a diary of the electronic apparatus can be reduced.

It is possible that a control unit may control the storage unit to store the movie image together with the user activity and/or the received signal or data. It is also possible that the control unit can control the storage unit to store the movie image together with an indication of the user activity or the received signal or data

It is also possible that data of a movie played as an activity can be compressed using a data compressing method and then stored in the storage unit. Accordingly, stored activities may include a data compressed activity and/or a non-data compressed activity. The data compress activity can be reproduced using a data decompressing method.

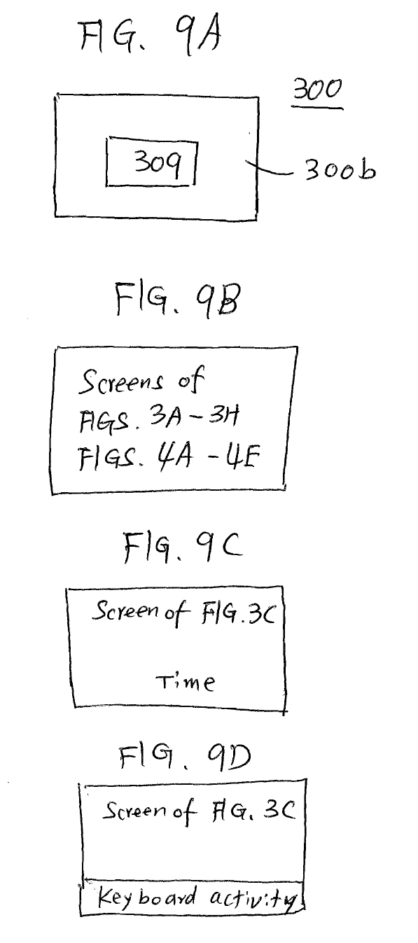

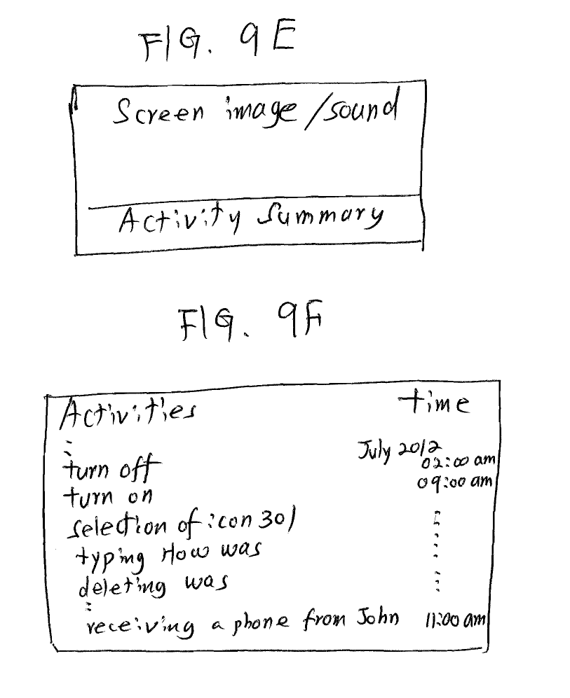

FIGS. 9A through 9F are views illustrating a screen 300 of a display unit of an electronic apparatus according to an embodiment of the present inventive concept. The screen shows a screen image 300b with an icon 309 for a user to select a diary menu of the electronic apparatus to set up the diary menu, to start a diary application or to store activity of the electronic apparatus as described above, or to read and reproduce the stored diary or to transmit the diary to an external device through an interface communicating with the external device through a wired or wireless communication.

Referring to FIG. 9B, the stored diary is displayed. The stored diary may include at least one of the above-described activities of the electronic apparatus. For example, screen images of FIGS. 3A through 3H and screen images of FIGS. 4A through 4E are displayed during a diary reproducing operation of the electronic apparatus. It is possible that screen images between FIG. 3C and FIG. 3C can be stored and reproduced. That is, screen images of a deleting process of deleting “s,” “a,” “w” in order which corresponds to deleting of “was,” can be stored and reproduced in FIG. 9B.

Referring to FIG. 9C, a screen image may reproduced with a time of the activity. The screen image may include a screen of an activity, for example, FIG. 3C, and a corresponding activity time on the same screen of the display unit. Referring to FIG. 9D, a user activity can be displayed with the screen image of FIG. 3C on the same screen of the display unit. Referring to FIG. 9E, an activity summary statement can be displayed with the screen image and/or sound. It is possible that a combination of the activity screen, the time, and the summary statement can be displayed on the same screen. It is also possible that the time, user activity, and/or activity summary statement can be respectively or separately displayed on a display screen of a corresponding display unit when the display unit is a plurality of display units.

Referring to FIG. 9F, the activity summary and time may be displayed on the screen of the display unit. The screen of FIG. 9F may not include the screen image of the activities stored in a storage unit.

According to an embodiment of the present inventive concept, an electronic apparatus stores in a storage unit screen images and/or sound associated with the screen images generated and displayed on a display unit and an audio unit, respectively, and read and reproduce the stored screen image and/or sound as a diary of the electronic apparatus.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include a read-only memory (ROM), a random-access memory (RAM), a flash memory, a semiconductor chip package, CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. An electronic apparatus to perform an operation and to display an image according to the performed operation, comprising:
a storage unit;
a display unit to display a plurality of screen images according to an activity of the electronic apparatus; and
a control unit to control the storage unit to store the displayed screen images as a diary of the electronic apparatus.

2. The electronic apparatus of claim 1, wherein the activity is associated with an operation of a user selected menu of the electronic apparatus.

3. The electronic apparatus of claim 1, wherein the activity of the electronic apparatus is not associated with an operation of a user selected menu in the electronic apparatus.

4. The electronic apparatus of claim 1, wherein the activity corresponding to the screen images includes one or more of:
an initial activity corresponding to an initiation of the menu;
a final activity corresponding to a completion of an operation of the menu; and
an intermediate activity between the initiation of the operation and the completion of the operation.

5. The electronic apparatus of claim 1, wherein the activity corresponding to the screen images includes one or more of:
an interactive activity in which a user interacts with the electronic apparatus; and
a non-interactive activity in which a user does not interact with the electronic apparatus.

6. The electronic apparatus of claim 1, wherein the activity corresponding to the screen images includes one or more of:
an image only activity;
a sound only activity; and
a combination activity having an image and sound generating during the performance of the operation thereof.

7. The electronic apparatus of claim 1, wherein the activity corresponding to the screen images includes one or more of:
an exposed activity; and
an unexposed activity

8. The electronic apparatus of claim 1, further comprising:
a user interface to receive a user input to set up the activity,
wherein the activity corresponding to the screen images includes one or more of:
a user setting activity which is set through the user interface; and
a non-user setting activity which is not set through the user interface.

9. The electronic apparatus of claim 1, further comprising:
an interface to communicate with an external device,
wherein the activity of the screen images includes another activity occurring in the electronic apparatus according to data received from an external device.

10. The electronic apparatus of claim 1, further comprising:
an interface to communicate with an external device,
wherein the screen images include an image representing another activity occurring in the electronic apparatus according to data received from an external device.

11. The electronic apparatus of claim 1, wherein the control unit generates a summary statement representing the screen images and controls the storage unit to store the generated summary statement.

12. The electronic apparatus of claim 1, wherein the stored screen images include a data compressed image and a non-data compressed image.

13. The electronic apparatus of claim 1, wherein:
the display unit displays a main screen of the electronic apparatus and displays one or more subsequent images according to a menu of the main screen, as the screen images of the activity; and
the control unit controls the storage unit to store the screen images including the main screen and the subsequent images according to a change from the main screen to the one or more subsequent images or a selection of the menu of the main screen.

14. The electronic apparatus of claim 1, wherein:
the control unit controls the storage unit to store the displayed screen images as a first unit file of the diary of the electronic apparatus;
the display unit displays one or more second screen images according to a second activity of the electronic apparatus; and
the control unit controls the storage unit to store the displayed one or more second screen images as a second unit file of the diary of the electronic apparatus.

15. The electronic apparatus of claim 14, wherein the screen images and the second screen images include a common screen image.

16. The electronic apparatus of claim 14, wherein the control unit controls the storage unit to combine the first unit file and the second unit file into a main file of the diary of the electronic apparatus.

17. The electronic apparatus of claim 1, wherein the control unit reads the stored screen images and controls the display unit to display the read screen images as the diary of the electronic apparatus.

18. The electronic apparatus of claim 1, wherein the control unit reads the stored screen images and transmits the read screen images to an external device.

19. An electronic apparatus to perform an operation and to display an image according to the performed operation, comprising:
a storage unit;
a display unit to display one or more screen images according to an activity of the electronic apparatus; and
a control unit to control the storage unit to store the displayed one or more screen images in order as a diary of the electronic apparatus, to read the stored screen images, and to controls the display unit to display the read screen images, wherein the storage unit, the display unit, and the control unit are formed in a single body.

20. A method of an electronic apparatus to perform an operation and to display an image according to the performed operation, the method comprising:
displaying a plurality of screen images on a display unit according to an activity of the electronic apparatus; and
controlling a storage unit to store the displayed screen images as a diary of the electronic apparatus.
